(19) United States
(12) Patent Application Publication
(10) Pub. No.: US 2023/0077987 A1
(43) Pub. Date: Mar. 16, 2023

(54) ARTIFICIAL NEURAL NETWORK AND COMPUTATIONAL ACCELERATOR STRUCTURE CO-EXPLORATION APPARATUS AND METHOD

(71) Applicant: UIF (University Industry Foundation), Yonsei University, Seoul (KR)

(72) Inventors: Jin Ho LEE, Seoul (KR); Young Sok KIM, Seoul (KR); Kang Hyun CHOI, Seoul (KR); Deok Ki HONG, Seoul (KR)

(73) Assignee: UIF (University Industry Foundation), Yonsei University, Seoul (KR)

(21) Appl. No.: 17/541,861

(22) Filed: Dec. 3, 2021

(30) Foreign Application Priority Data
Sep. 13, 2021 (KR) 10-2021-0121891

(51) Int. Cl. G06N 3/04; G06K 9/62; G06F 9/50

(52) U.S. Cl. CPC G06N 3/0481; G06K 9/6227; G06K 9/6262; G06F 9/5027

(57) ABSTRACT

An artificial neural network and computational accelerator structure co-exploration apparatus, includes: a neural architecture search (NAS) module configured to determine neural network architecture, and a differentiable accelerator and network co-exploration (DANCE) evaluation module configured to determine accelerator architecture according to the determined neural network architecture and predict hardware metrics for the determined accelerator architecture.

### ACKNOWLEDGEMENT

National R&D Project Supporting the Present Invention

Project Serial No.: 1711126082

Project No.: 2020-0-01361-002

Department: Ministry of Science and ICT

Project management (Professional) Institute: Institute of Information & Communication Technology Planning & Evaluation

Research Project Name: Information & Communication Broadcasting Research Development Project

Research Task Name: Artificial Intelligence Graduate School Support (Yonsei University)

Contribution Ratio: 1/2

Project Performing Institute: Yonsei University Industry Foundation

Research period: 2021.01.01.˜2021.12.31.

Project Serial No.: 1711134555

Project No.: 2021-0-00853-001

Department: Ministry of Science and ICT

Project management (Professional) Institute: Institute of Information & Communication Technology Planning & Evaluation

Research Project Name: Developing a new concept of PIM semiconductor leading technology(R&D)

Research Task Name: Development of SW platform to utilize PIM Contribution rate: 1/2

Project Performing Institute: Yonsei University Industry Foundation

Research period: 2021.04.01.˜2021.12.31.

### CROSS-REFERENCE TO RELATED APPLICATION

This application claims priority to Korean Patent Application No. 10-2021-0121891 (filed on Sep. 13, 2021), which is hereby incorporated by reference in its entirety.

### BACKGROUND

The present disclosure relates to a co-exploration technology of an artificial neural network and a dedicated hardware accelerator, and more specifically, to an artificial neural network and a computational accelerator structure co-exploration apparatus and method capable of finding an optimal point to balance accuracy of the artificial neural network and hardware metrics while efficiently exploring an exploration space within a specific time.

As a result of decades of research by researchers, DNNs are now demonstrating near-human performance in a variety of applications, such as image classification and board game play. However, this success is due to the explosive compute intensity, which requires a long GPU training time and a lot of hardware cost.

A neural architecture search (NAS) may correspond to an approach to solving this problem. In the past, it started with the goal of reducing human design effort and achieving the latest accuracy, but recently hardware-related costs such as latency are being considered.

Another approach to solve the problem may be to use special hardware (sometimes called an ‘accelerator’). Good latency and/or cost may be achieved when utilizing accelerators specific to DNN execution. For example, Google TPU is being distributed to accelerate processing of AlphaGo, data center and cloud services. Designing a dedicated accelerator may incur another large-scale design challenge to optimize latency as well as other hardware cost metrics such as energy consumption and area.

However, network architecture and an accelerator are not independent of each other and intensive optimization of any one of the network architecture and the accelerator may often adversely affect the other. For example, commonly used separable convolutions may achieve good latency, usually due to their low computational requirements. However, some types of accelerators, such as Google's TPU, may be designed to utilize a large number of output channels for parallelism. For this reason, the separable convolutions executed in the TPU may have a longer delay time compared to the general convolution operation despite the small number of operations. Similarly, optimizing only the accelerator without considering the network may often result in a suboptimal option that is not the best option.

In this regard, the co-exploration of the hardware accelerator and the network architecture may be very important in achieving the desired application performance (i.e., accuracy) and reasonable cost (latency, area, and energy consumption). The existing co-exploration techniques typically use reinforcement learning (RL) techniques.

The techniques may first generate a network and accelerator pair, which may be evaluated by training a network for accuracy and measuring hardware cost metrics. After evaluation, a reward function may be calculated, and a new design pair may be generated based on the reward. The obvious problem with this procedure may require a lot of exploration time. Similar to the RL-based NAS technology, the generated network needs to be fully trained for accuracy evaluation. In addition, the accelerator evaluation may often take non-negligible time and resources. Accordingly, there is a problem in that the exploration requires an excessive amount of time and it is still difficult to obtain a high-quality solution.

### RELATED ART DOCUMENT

### Patent Document

(Patent Document 0001) Korean Patent Laid-Open Publication No. 10-2019-0101677 (Sep. 2, 2019)

### SUMMARY

The present disclosure provides an artificial neural network and computational accelerator structure co-exploration apparatus and method capable of finding an optimal point to balance an accuracy of the artificial neural network and hardware metrics while efficiently exploring an exploration space within a specific time.

The present disclosure provides an artificial neural network and computational accelerator structure co-exploration apparatus and method capable of completing exploration by training an artificial neural network representing the entire exploration space once by conducting exploration using gradient descent, thereby enabling very fast exploration and optimizing direct hardware metrics such as latency or energy consumption in a differentiable approach.

In an aspect, an artificial neural network and computational accelerator structure co-exploration apparatus includes: a neural architecture search (NAS) module configured to determine neural network architecture; and a differentiable accelerator and network co-exploration (DANCE) evaluation module configured to determine accelerator architecture according to the determined neural network architecture and predict hardware metrics for the determined accelerator architecture.

The NAS module may simultaneously evaluate a plurality of candidate neural network architectures to select the neural network architecture and calculate a cross-entropy loss (LossCE).

The DANCE evaluation module may be constructed through pre-training, and include a hardware generation network configured to be built through pre-training, explore optimal hardware according to the determined neural network architecture as the accelerator architecture, and determine at least one of a processing element (PE) array configuration (PEx and PEy), a register file (RF) configuration, and a dataflow (DF) configuration, and a cost estimation network configured to predict the hardware metrics based on configurations of the accelerator architecture.

The hardware generation network may generate random networks within a network architecture space and determine one of the random networks as the optimal hardware.

The hardware generation network may explore the random networks by being configured as multi-layer perceptrons using a rectified linear unit (ReLU) as an activation function.

The hardware generation network may make an output value approach an input value of the cost estimation network in a manner of feature forwarding the output value to the input value by connecting the last of the multi-layer perceptrons with Gumbel-Softmax.

The cost estimation network may be configured as a multi-layer regression that uses a rectified linear unit (ReLU) as an activation function and applies batch normalization to each layer.

The cost estimation network may predict the hardware metrics by determining latency, area, and energy consumption through the multi-layer regression.

The cost estimation network may predict the hardware metrics by calculating a linear combination or a product of the latency, the area, and the energy consumption.

In another aspect, an artificial neural network and computational accelerator structure co-exploration method includes: performing a NAS module that determines neural network architecture; and performing a DANCE evaluation module that determines accelerator architecture according to the determined neural network architecture and predicts hardware metrics for the determined accelerator architecture.

The performing of the DANCE evaluation module constructed through pre-training may include: performing a hardware generation network that explores optimal hardware according to the determined neural network architecture as the accelerator architecture, and determines at least one of a processing element (PE) array configuration (PEx and PEy), a register file (RF) configuration, and a dataflow (DF) configuration; and performing a cost estimation network that predicts the hardware metrics based on configurations of the accelerator architecture.

The performing of the hardware generation network may include generating random networks within a network architecture space and determining one of the random networks as the optimal hardware.

The performing of the hardware generation network may explore the random networks by being configured as multi-layer perceptrons using a rectified linear unit (ReLU) as an activation function.

The performing of the cost estimation network may include configuring the cost estimation network as a multi-layer regression that uses a rectified linear unit (ReLU) as an activation function and applies batch normalization to each layer.

The disclosed technology may have the following effects. However, since a specific embodiment is not construed as including all of the following effects or only the following effects, it should not be understood that the scope of the disclosed technology is limited to the specific embodiment.

According to the present disclosure, an artificial neural network and computational accelerator structure co-exploration apparatus and method may find an optimal point to balance an accuracy of the artificial neural network and hardware metrics while efficiently exploring an exploration space within a specific time.

According to the present disclosure, an artificial neural network and computational accelerator structure co-exploration apparatus and method may complete exploration by training an artificial neural network representing the entire exploration space once by conducting exploration using gradient descent, thereby enabling very fast exploration and optimizing direct hardware metrics such as latency or energy consumption in a differentiable approach.

### BRIEF DESCRIPTION OF THE DRAWINGS

FIG. 1 is a diagram for describing a functional configuration of a co-exploration apparatus according to the present disclosure.

FIG. 2 is a flowchart for describing an embodiment of a method for integrating an artificial neural network and a computational accelerator structure according to the present disclosure.

FIGS. 3 and 4 are diagrams for describing CNN execution with 7 dimensions in a convolutional layer.

FIG. 5 is a diagram for describing an embodiment of a DNN accelerator.

FIG. 6 is a diagram for describing an RL-based co-exploration process.

FIG. 7 is a diagram for describing an artificial neural network and computational accelerator structure co-exploration method according to the present disclosure.

FIG. 8 is a diagram for describing evaluation network architecture according to the present disclosure.

FIG. 9 is a diagram for describing an effect of feature map binarization according to the present disclosure.

FIGS. 10 and 11 are diagrams for describing an embodiment of an exploration network and accelerator design according to the present disclosure.

### DETAILED DESCRIPTION

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. In addition, other expressions describing a relationship between components, that is, “between”, “directly between”, “neighboring to”, “directly neighboring to” and the like, should be similarly interpreted.

It should be understood that the singular expression include the plural expression unless the context clearly indicates otherwise, and it will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In each step, an identification code (for example, a, b, c, and the like) is used for convenience of description, and the identification code does not describe the order of each step, and each step may be different from the specified order unless the context clearly indicates a particular order. That is, the respective steps may be performed in the same sequence as the described sequence, be performed at substantially the same time, or be performed in an opposite sequence to the described sequence.

The present disclosure may be embodied as computer readable code on a computer-readable recording medium, and the computer-readable recording medium includes all types of recording devices in which data may be read by a computer system. Examples of the computer readable recording medium may include a read only memory (ROM), a random access memory (RAM), a compact disk read only memory (CD-ROM), a magnetic tape, a floppy disk, an optical data storage, or the like. In addition, the computer readable recording medium may be distributed in computer systems connected to each other through a network, such that the computer readable codes may be stored in a distributed scheme and executed.

Unless defined otherwise, all the terms used herein including technical and scientific terms have the same meaning as meanings generally understood by those skilled in the art to which the present disclosure pertains. It should be understood that the terms defined by the dictionary are identical with the meanings within the context of the related art, and they should not be ideally or excessively formally defined unless the context clearly dictates otherwise.

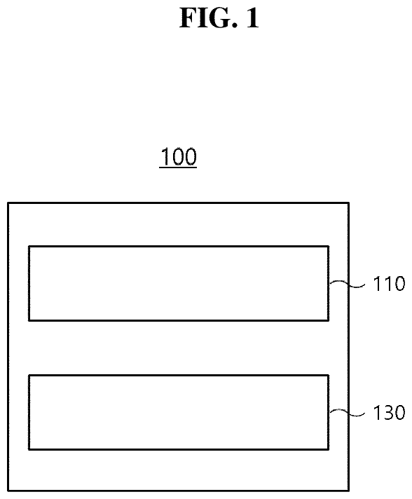

FIG. 1 is a diagram for describing a functional configuration of a co-exploration apparatus according to the present disclosure.

Referring to FIG. 1, a co-exploration apparatus 100 may complete exploration by training an artificial neural network representing the entire exploration space once, thereby enabling very fast exploration and optimizing direct hardware metrics such as latency or energy consumption in a differentiable approach. As a configuration for this, the co-exploration apparatus 100 may be implemented including a neural architecture search (NAS) module 110 and a differential accelerator and network co-exploration (DANCE) evaluation module 130.

The NAS module 110 may perform an operation of determining the neural network architecture, and the DANCE evaluation module 130 may perform an operation of determining accelerator architecture corresponding to neural network architecture determined by the NAS module 110 and predicting hardware metrics for the accelerator architecture.

More specifically, the NAS module 110 may select the neural network architecture by simultaneously evaluating a plurality of candidate neural network architectures, and may calculate a cross-entropy loss (Loss_{CE}) related thereto.

In one embodiment, the DANCE evaluation module 130 may be constructed through pre-training, and may be configured to include two networks. That is, the DANCE evaluation module 130 may include a hardware generation network and a cost estimation network.

First, the hardware generation network is optimal hardware accelerator architecture according to the neural network architecture determined by the NAS module 110, and may perform an operation of performing exploration and determining at least one of a processing element (PE) array configuration (PEx and PEy), a register file (RF) configuration, and a dataflow configuration for the accelerator architecture. That is, the hardware generation network may be pre-trained to explore the optimal hardware architecture, and may generate optimal configurations for the optimal hardware architecture as parameters. For example, the hardware generation network may generate, as an output, the features PEx and PEy, the register file RF, the dataflow DF, and the like of the PE array for the optimal hardware architecture.

In one embodiment, the hardware generation network may generate random networks within the network architecture space and determine one of the random networks as the optimal hardware. That is, the hardware generation network may receive a random network as an input and may generate an output that may be used as a ground-truth for training the evaluator network.

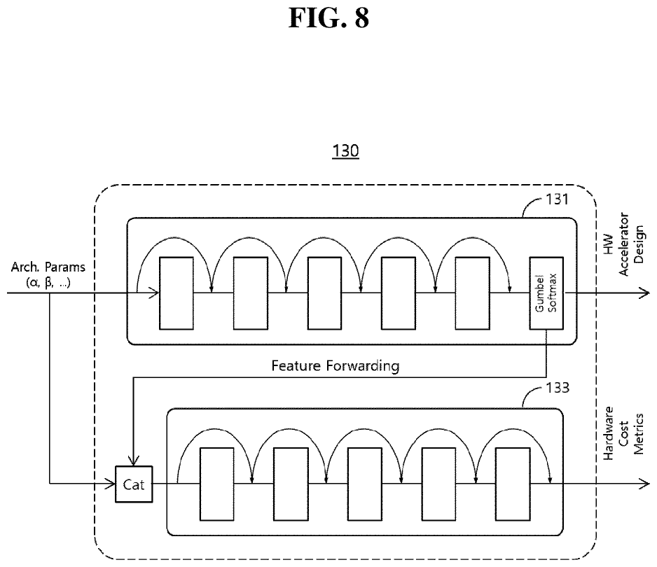

In an embodiment, the hardware generation network may explore the random networks by being configured as multi-layer perceptrons using a rectified linear unit (ReLU) as an activation function. For example, as illustrated in FIG. 8, the hardware generation network 131 may be configured as a five-layer perceptron.

In an embodiment, the hardware generation network 131 may make an output value approach an input value of the cost estimation network in a manner of feature forwarding the output value to the input value by connecting the last of the multi-layer perceptrons with Gumbel-Softmax. For example, as illustrated in FIG. 8, the hardware generation network 131 may be implemented to apply the Gumbel-Softmax to the last of the five-layer perceptron and connect the output to the input of the cost estimation network 133. Here, the Gumbel-softmax may correspond to a softmax function that may train how to probabilistically sample a single element from a set.

In addition, the cost estimation network may perform an operation of predicting hardware metrics based on configurations related to the accelerator architecture. In an embodiment, the cost estimation network may be configured as a multi-layer regression that uses the rectified linear unit (ReLU) as the activation function and applies batch normalization to each layer. For example, the cost estimation network 133 may be configured as the five-layer regression as illustrated in FIG. 8. In this case, the cost estimation network 133 may include a residual connection between layers.

In an embodiment, the cost estimation network may predict the hardware metrics by determining latency, area, and energy consumption through multi-layer regression. In this case, the ground truth generated by the evaluation software may be used in the cost estimation process.

In one embodiment, the cost estimation network may predict the hardware metrics by calculating a linear combination or a product (combination and product) of the latency, the area, and the energy consumption. That is, the cost estimation network may predict hardware metrics using the cost function, and the cost function may be defined as a linear combination of the latency, the area, and the energy consumption, or may be defined as the combination and the product between the latency, the area, and the energy consumption.

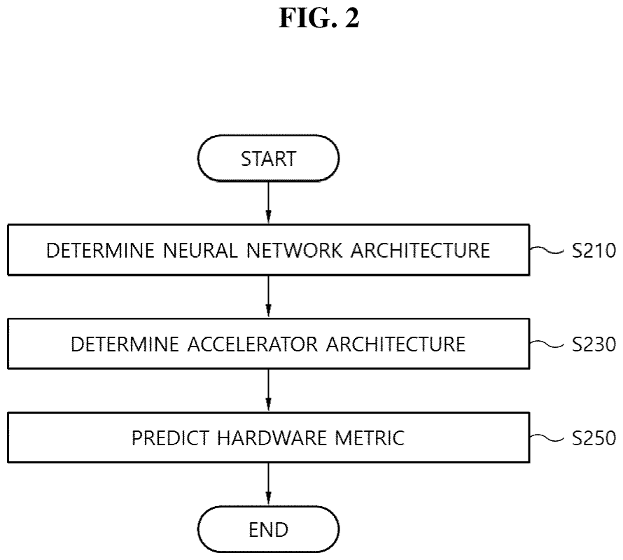

FIG. 2 is a diagram for describing an artificial neural network and computational accelerator structure co-exploration method according to an embodiment of the present disclosure.

Referring to FIG. 2, the co-exploration apparatus 100 may determine the neural network architecture through the NAS module 110 (step S210). The co-exploration apparatus 100 may determine the accelerator architecture according to the neural network architecture through the DANCE evaluation module 130 (step S230). The co-exploration apparatus 100 may determine the accelerator architecture according to the neural network architecture through the DANCE evaluation module 130 (step S250).

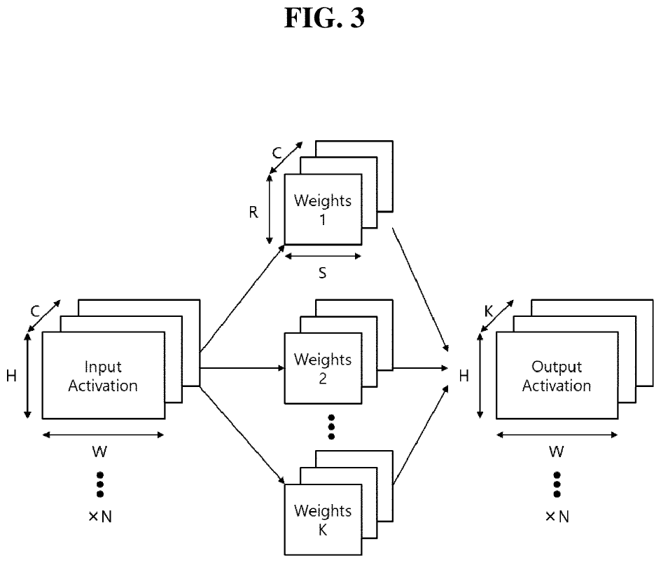

Hereinafter, the artificial neural network and computational accelerator structure co-exploration method according to the present disclosure will be described in more detail with reference to FIGS. 3 to 11.

The neural architecture search (NAS) may automate the design of DNN architectures to cope with the increasing network sizes and the corresponding manual design efforts. Early in the neural architecture search, reinforcement learning (RL) or evolutionary algorithms (EA) have been adopted for network generation.

However, in the case of these algorithms, the search cost may be very high, and may consume several thousand GPU-days due to the full training required for all candidates. A search for a differentiable neural architecture according to the present disclosure may generate a supergraph and find a path therein as a way to alleviate these costs. In other words, the search for differentiable neural architectures may find networks with state-of-the-art performance in orders of magnitude shorter time.

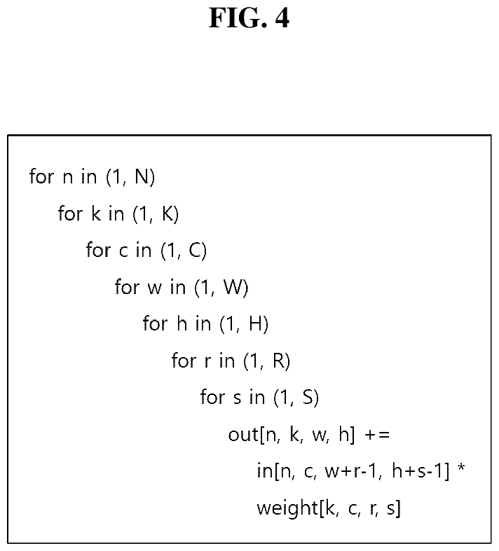

Hardware accelerators for DNNs focus on parallel execution of multiple MAC (Multiply-Accumulate) operations, which are the most common operations in recent CNNs. FIG. 5 illustrates one embodiment of an Eyeriss-like DNN accelerator that includes on-chip memory, a number of processing elements (PEs), and interconnections therebetween. Even with the backbone accelerator design, many attributes still need to be designed, such as the number of PEs, the dataflow, the register file size, etc.

In general, the DNN layer may include multiple dimensions of computational operations. For example, the convolutional layer may include seven computing operation layers as illustrated in FIG. 3. That is, the convolutional layer (convolutional layer) may include three layers for input activations H, W, and C, three layers for weights R, S, K, and one layer for batches N. Therefore, it may be formulated as 7-step nested loops as illustrated in FIG. 4. Mapping and ordering these loops in the accelerator may often be referred to as a dataflow, and many accelerators may provide a variety of dataflows that focus on keeping some data on a local memory for as long as possible.

Analysis of how each choice affects the DNN latency in the accelerator design may be performed by a simulator or an analytical evaluation tool. The co-exploration method according to the present disclosure may utilize Timeloop combined with Accelergy as a state-of-the-art accelerator evaluation toolchain for training evaluation networks on the DANCE framework.

In the method of co-exploration of network architecture and accelerator design, existing methods may use the reinforcement learning (RL) as a controller due to a relatively simple method of formulating a problem. However, all of these methods may include the same search cost problem that occurs in the reinforcing learning-based NAS algorithm.

In contrast, the method according to the present disclosure may apply the idea of a differentiable NAS to a joint exploration problem, which may greatly reduce the cost of exploration while creating a network and accelerator design with the highest accuracy. The existing method called EDD can provide a differentiable method for joint exploration problems. However, the method may have some important limitations. The EDD may be modeled as latency (latency) obtained by dividing a total of flops of the network by the amount of computational resources. As a result, the true relationship between the network architecture and the accelerator design may not be considered in co-search. This may theoretically not allow searches for some important characteristics such as the dataflow or the register file size. Also, the main focus of the EDD may be to use various types of quantization for each layer. Therefore, the EDD may include the assumption that there is (shareable) dedicated hardware for each layer and there is a difference from general accelerators.

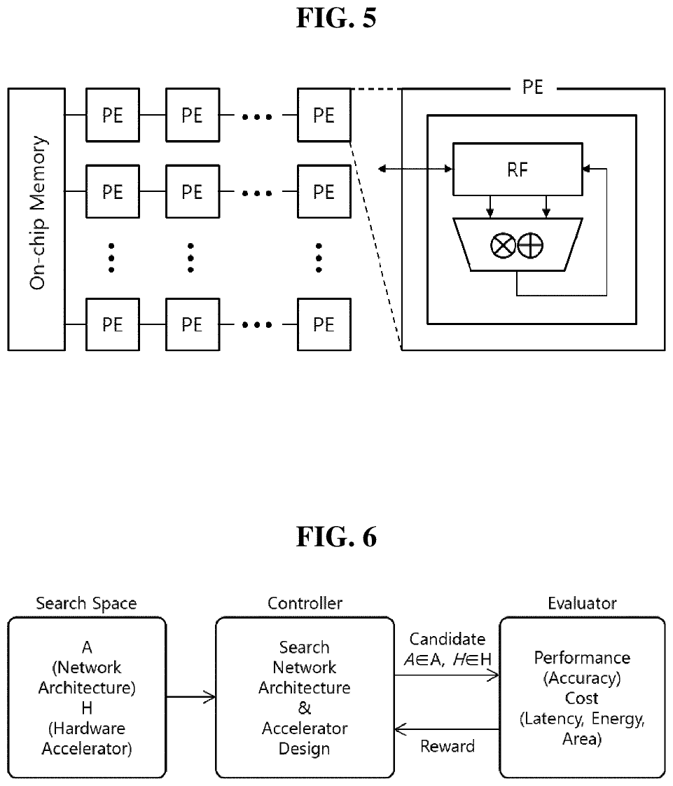

Referring to FIG. 6, a method for performing RL-based co-exploration is illustrated. Black letters may mean components of general NAS algorithms, and blue letters may mean components added for co-exploration. First, the search space of the network architecture and the hardware accelerator may be provided to the controller. Then, the controller may generate candidate designs for the provided search space (i.e., network architecture and hardware accelerator). The generated candidates may be trained on the network to obtain accuracy, and passed to an evaluator who analyzes cost metrics for specified hardware executing the network. The method serves the purpose of co-exploration well, but may involve the training cost which is the same problem of the RL-based NAS algorithm. That is, the method may require expensive training for each candidate generated. In addition, the operation of finding the optimal hardware design in the corresponding method may take a considerable amount of time as long as it is performed for each candidate. As a result, the search operation of the method may suffer from many GPU-hours.

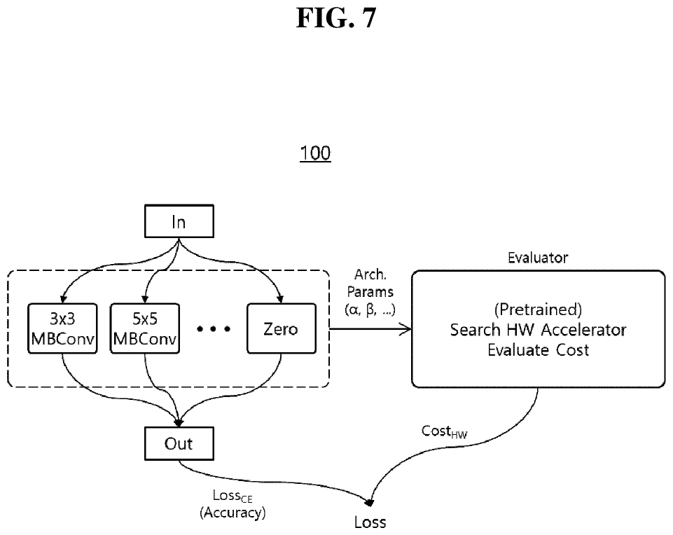

Referring to FIG. 7, a co-exploration method executed in the co-exploration apparatus 100 according to the present disclosure is illustrated. That is, the co-exploration method according to the present disclosure may correspond to a differentiable co-exploration method called the differentiable accelerator/network co-exploration (DANCE). The left part of FIG. 7 may correspond to a network search module (that is, corresponding to the NAS module 110 of FIG. 1) similar to other differentiable NAS algorithms, and find the super-network using the backpropagation to generate a finally searched network. On the other hand, it goes without saying that all other differentiable NAS algorithms may be applied to the network search module.

The right part of FIG. 7 may correspond to a differentiable evaluator (i.e., corresponding to the DANCE evaluation module 130 of FIG. 1) that searches for an optimal hardware accelerator design and evaluates cost metrics using the architectural parameters obtained from the network search module. The evaluator may be implemented as a pre-trained neural network, frozen during the search, and used in the process of linking the corresponding hardware architecture to the hardware cost metrics. The loss function may be expressed as in Equation 1 below, and both accuracy and cost metrics may be considered.

Loss=Loss_{CE}+λ₁∥w∥+λ₂ Cost_{HW} [Equation 1]

Here, λ₁ and λ₂ are hyperparameters that adjust a trade-off between terms. The Loss_{CE} is a cross-entropy loss and ∥w∥ is a weight decay term. Also, Cost_{HW} is a cost function of the hardware accelerator calculated from the output value of the evaluator network. For example, the cost function may correspond to a linear combination of the latency, the area, and the energy consumption, or correspond to energy-delay-area product (EDAP).

Original (non-differentiable) cost estimation software may be composed of a hardware generation tool and a cost estimation tool. A hardware generation tool may use network architecture as an input and generate a hardware accelerator design as an output.

The co-exploration method according to the present disclosure may use a dataflow as a search space of a hardware accelerator design, the number of PEs in the X and Y dimensions, and the register file size. Thereafter, the cost estimation tool may generate cost metrics as an output using the hardware accelerator and the network architecture. In general, the hardware generation tool may be implemented as an outer loop containing the cost estimation tool. That is, the hardware generation tool may generate as output an optimal solution for a given network architecture A within a hardware search space H by using an exact algorithm such as an exhaustive exploration or branch-and-bound algorithm.

In an embodiment, the co-exploration method according to the present disclosure may use Timeloop for latency and Accelergy for energy/area in the cost estimation process. In this case, the Timeloop and Accelergy may correspond to a state-of-the-art cost estimation toolchain. The co-exploration method according to the present disclosure may design a unique hardware generation tool using the cost estimation tool. The co-exploration method according to the present disclosure may generate a random network as an input on the network architecture space A, and the output of the toolchain may be used as the ground-truth for training the components of the evaluator network.

The evaluator network according to the present disclosure may include two modules: a hardware generation network and a cost estimation network. Referring to FIG. 8, the evaluator network architecture according to the present disclosure is illustrated. The hardware generation network may be modeled as a five-layer perceptron using the rectified linear unit (ReLU) as the activation function. In the hardware generation networks, residual connections may be applied between layers to increase the accuracy of the cost estimation network and to establish a gradient path for the network being explored.

The cost estimation network may be modeled as a five-layer regression with the residual connections. The cost estimation network may include the ReLU as the activation function, and the batch normalization may be applied to all layers. The cost estimation network may generate as output the three cost metrics of interest (i.e., latency, area, and energy consumption) based on the ground truth generated by the evaluation software. For example, the evaluation software may include Timeloop and Accelergy. The present disclosure may use a mean squared relative error (MSRE) loss to train each evaluator network, and may be expressed as Equation 2 below.

Loss_{MRSE}=Σᵢ(1−ŷᵢ,yᵢ)² [Equation 2]

Here, yᵢ is the hardware cost function (Cost_{HW}) for each metric generated from the results of the Timeloop+Accelergy, and ŷᵢ is the same cost function calculated using the network output. A general MSE loss may be used, but in this case, there may be a problem of giving inappropriate weights to metrics having high values. For example, the latency value output in the search space may be in the range from 8 ns to 100 ns or more for each layer. In case of using the MSE loss, 10 ns error (error) of 8 ns latency and 10 ns error of 100 ns latency are regarded as the same, thereby giving an unfair advantage to more accurately modeling situations with long latency. That is, under the condition of finding the accelerator with low latency, the MSRE loss may be more desirable.

In the evaluator architecture, the cost estimation network that outputs the HW cost metrics may mean that two functions of finding the optimal hardware and estimating the metrics should be modeled internally. A standalone network may show significantly higher accuracy, but latency may be further improved by adding a feature forwarding path in the output of the hardware generation network. That is, the output of the hardware generation network may be connected to the network architecture as an input to the cost estimation network. For example, when the Gumbel softmax is used as the last layer of the hardware generation network, the output value of the hardware generation may be as close as possible to the input of the cost estimation network.

Compared to optimizing the classification accuracy of an application, optimizing the cost metrics may correspond to a relatively easier task in the gradient decent. For example, selecting 0 for most of the layers may quickly optimize all latency, area, and energy consumption. When the network architecture is limited to these solutions, it may be difficult to find a more critical architecture, even if necessary to optimize for the highest accuracy. To mitigate this effect, hyperparameter warm-up scheduling may be used. The hyperparameter warm-up scheduling may use λ₂ in Equation 1 as a small value for first few epochs and increase λ₂ to a desired value later after the network architecture reaches a certain stage for high accuracy.

Basically, the hardware cost function may use a linear combination of the three hardware cost metrics as the cost function CostHW of Equation 1, and may be expressed as Equation 3 below.

Cost_{HW_linear}=λ_{E}Energy+λ_{L}Latency+λ_{A}Area [Equation 3]

By controlling λ_{E}, λ_{L}, and λ_{A}, conditions for how to measure the balance between each cost metric may be set. To match the scale of these hyperparameters, mJ, ms, and μm² units may be used for each cost.

In addition, the hardware cost function may use a product of all metrics as the cost function, and may be expressed as Equation 4 below.

Cost_{HW}_{_{_EDAP}}=Energy·Latency·Area [Equation 4]

Here, the EDAP corresponds to common metrics (e.g., energy-delay-area product) used to evaluate hardware. In this case, it may be advantageous in that there are no additional hyperparameters and no units.

Hereinafter, the experimental results regarding the present disclosure will be described.

Several experiments may be performed based on the CIFAR-10 and ImageNet (ILSVRC2012) datasets for the co-exploration method (i.e., DANCE) according to the present disclosure. All algorithms may be implemented in PyTorch and run on four RTX2080Ti GPUs.

Search Space

For H, which is a hardware accelerator search space, the latest accelerator Eyeriss may be used as a backbone. As design parameters, the number of PEs, the RF size, and the dataflow may be used. In the case of a two-dimensional PE array, variables PEX and PEY may be allocated separately for each dimension. Here, the range of each value may be 8 to 24. In the configuration, the larger the PEX, the more channels the layers may have, and the larger the PEY, the larger the feature maps may be used for parallelism. The RF size per PE may have a value between 4 and 64. In the case of the dataflow, three dataflows may be selected from existing hardware accelerators (i.e., weight stationary (WS), output stationary (OS), row stationary (RS)). About 128 GB/s of HBM memory may be set for off-chip memory. Each variable on the evaluator network may be formulated as a one-hot vector to simplify the cascaded connection between the hardware generation network and the cost estimation network.

In the case of A, which is a network architecture search space, ProxylessNAS may be used as a backbone network architecture. There are 13 layers in the network, and the number of channels may increase for every 3 layers.

In addition to the skip connection, each of the nine intermediate layers may include seven candidate operations of MBConv3×3_expand3, MBConv3×3_expand6, MBConv5×5_expand3, MBConv5×5_expand6, MBConv7×7_expand3, MBConv7×7_expand6, and Zero When Zero is selected, only skipped connections may be included, and the layer can effectively disappear from the network. The architectural parameters may be learned through a binarized method (e.g., ProxylessNAS).

Evaluator Network Results

1) Cost Estimation Network: Table 1 below corresponds to the experimental results for the components of the evaluator network.

TABLE 1

| Network | Accuracy | | | |
|---|---|---|---|---|
| Hardware Generation | PE_{X} | PE_{Y} | RF_Size | Dataflow |
| | 98.9% | 98.3% | 98.3% | 98.8% |
| Cost Estimation | Latency | Energy | Area | |
| (w/o feature forwarding) | 93.7% | 96.3% | 92.8% | |
| Cost Estimation | Latency | Energy | Area | |
| (w/feature forwarding) | 99.6% | 99.7% | 99.9% | |
| Overall Evaluator | Latency | Energy | Area | |
| | 98.3% | 98.3% | 99.2% | |

The cost estimation network and the hardware generation network may be trained independently based on the ground truth values, and then combined with each other. Each layer of the cost estimation network may have a width of 256 and the network may be trained using an Adam optimizer with a training rate of 0.0001 for 200 epochs. A batch size of 256 may be applied. The cost estimation network may be trained on 1.8 million cases generated by Timeloop+Accelergy in the search space and verified on 450,000 cases. As a result, it may be shown that all three cost metrics are sufficiently accurate in that they show more than 99% accuracy. Also, it may be observed that the feature forwarding improves the accuracy to 4.3% p on average.

2) Hardware generation network: In the case of a hardware generation network, the layer width may be set to 128. As the loss function, a general CE loss may be used, and may be expressed as Loss_{CE_HW}. The hardware generation network may be trained using SGD with batch size of 128 for 200 epochs, and the training rate may start at 0.001 and decrease by a factor of 0.1 every 50 epochs. In addition, 50,000 network cases may be generated in the search space, and 10,000 cases may be used for validation. It may be confirmed that the accuracy of the hardware generation network is almost 99% in all hardware accelerator design parameters, which is sufficiently accurate. In other words, the hardware generation network is not only accurate and differentiable, but may also run much faster than the original generation toolchain. The inference time of the hardware generation network with the same function takes about 0.5 ms with a single GPU, while the generation tool takes about 112 seconds using 48 threads on 24 cores of two Intel Xeon Silver-4214 CPUs.

3) End-to-end evaluator network results: The entire evaluator network may be tested with the combination between the hardware generation network and the cost estimation network. Even if the median is not a one-hot vector, the Gumbel softmax may approximate it well and still maintain about 99% accuracy for cost metrics.

Co-Exploration Results

1) Experimental results for CIFAR-10: For the first baseline, a search may be performed using ProxylessNAS and hardware generation may be performed on the searched network using an exhaustive exploration tool. This may represent a typical separation design performed in practice. A search may be performed for 120 epochs with a batch size of 256 while a warm-up may be performed for 40 epochs. The SGD optimizer with Nesterov momentum may be used for searches using cosine scheduling with a learning rate of 0.025, weight reduction of 0.00004 (λ₁), label smoothing of 0.1, and momentum of 0.9. After the search, the final network may be trained from scratch for 300 epochs. The hyperparameters for training may be identical except that the training rate is 0.008 and the weight decay factor is 0.001. In addition, the EDD may be used as a second baseline. Since the EDD may not be applied to hardware parameters for dataflow and register files, the co-exploration is performed based on only the number of PEs, and the post search may be performed on the remaining parameters. A problem that may occur in the EDD is that a loss function that multiplies a classification loss by a latency loss is used, and it may be expressed as Equation 5 below.

Loss=λ₂·Loss_{CE}·ΣLatency [Equation 5]

Here, λ2 does not adjust the weight between the two terms. This may lead to serious problems where the network shrinks too much to quickly optimize latency. As a result, the solution may provide very low hardware cost but unacceptable accuracy. Therefore, in order to alleviate the problem, an experiment for changing the loss function as in Equation 1 may be performed, and may be expressed as EDD+Proposed Loss func.

Using the DANCE, the co-exploration may be performed based on cost functions. For CostHW_linear, three cost functions may be set: latency-oriented, energy-oriented, and balanced. All other hyperparameters may be set to be the same as the baseline. Similar to after-search training, one exact hardware generation after search may be performed to obtain an optimal hardware accelerator design.

Overall, the DANCE may achieve a better network accelerator design than the baseline. For comparison, two designs may be used, one with high accuracy (−A) and the other with an efficient hardware design (−B). For a high precision design (−A), the DANCE may achieve almost the same accuracy as the baseline (no penalty). For an efficient hardware design (−B), the design with the best cost function may be selected within a 1 to 2% accuracy reduction. The DANCE may perform efficient co-exploration to achieve up to 10× better EDAP or 3× better latency. Using the latency-oriented cost function, the latency is much lower than the other functions, while the energy-oriented cost function may achieve better energy consumption than the other two functions. As a result, using the DANCE may mean that may tune the cost hyperparameter to get the solution interested.

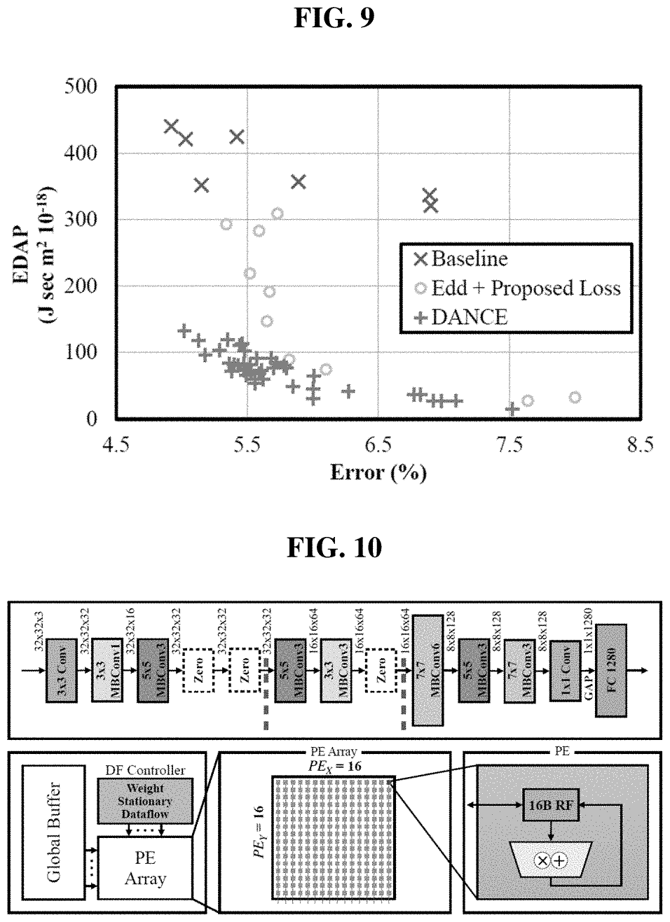

Referring to FIG. 9, it may mean that the DANCE searches for an overwhelming solution compared to baselines, rather than simply sacrificing accuracy for hardware cost. In FIG. 9, the EDAP-error relationship of the design found at the Baseline and the DANCE is shown. Here, for both axes, the lower, the better. A search may be performed for various λ₂ in Equation 1 above to achieve a different balance between accuracy and Cost_{HW}. The baseline and the DANCE may both reach similar accuracies with accuracy-oriented hyperparameter settings, but the DANCE may offer a much better trade-off and comes with a flops penalty, and may provide a cost metric that is better than the baselines. In addition, the DANCE may provide more than 2× better EDAP performance under similar accuracy compared to the EDD. This is because the EDD does not model network-hardware relationships and may not find efficient design pairs for solutions with particularly high accuracy. In the case of the EDD illustrated in FIG. 9, since the accuracy of the original EDD is too low, the modified loss function is used according to the present disclosure.

2) Experimental results for ImageNet: Table 2 below shows the performance of DANCE on the ImageNet dataset

TABLE 2

| Method | Acc. | Latency | Energy | EDAP |
|---|---|---|---|---|
| Baseline (No penalty) + HW | 71.12% | 23.3 ms | 71.6 mJ | 3014.0 |
| Baseline (Flops Penalty) + HW | 70.56% | 13.4 ms | 70.9 mJ | 2709.0 |
| EDD + Proposed Loss func. | 70.34% | 28.1 ms | 94.8 mJ | 5642.5 |
| DANCE (Cost_{HW}_{_{—}}_{EDAP}) | 69.82% | 7.5 ms | 42.7 mJ | 912.4 |
| DANCE (Energy-Oriented) | 69.55% | 9.2 ms | 49.5 mJ | 1413.5 |
| DANCE (Latency-Oriented) | 70.41% | 8.3 ms | 48.4 mJ | 1154.3 |
| DANCE (Balanced) | 70.15% | 7.7 ms | 45.7 mJ | 1001.8 |

Baseline with separate hardware search gives 71.12% accuracy. However, hardware may be expensive. When the Flops Penalty or the EDD are applied, it may not find an efficient solution. The DANCE may find a good trade-off point and may provide a much better cost metric with only a slight reduction in accuracy with up to 3×EDAP benefits.

Network and Accelerator Design Searched by DANCE

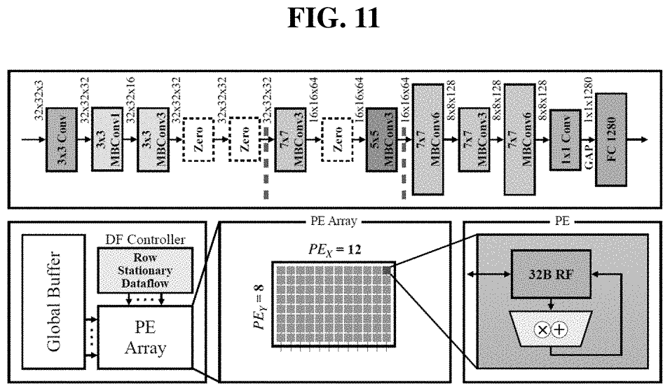

Referring to FIGS. 10 and 11, two sets of network architectures and accelerator designs are illustrated. Because it shows useful insights on how to find network architecture along with accelerator design, two cost-effective designs (−B) generated as the latency-oriented cost function and the energy-oriented cost function may be applied. In FIGS. 10 and 11, a value indicated by a bold character may correspond to design parameters that are searched as the DANCE.

The latency-oriented network (FIG. 10) may have a relatively small kernel size compared to the energy-oriented network (e.g., 3×3 MBConv instead of 7×7 MBConv). On the other hand, the latency-oriented network may include more channels according to a larger expansion ratio. Regardless of the dataflow, the accelerator may take advantage of channel-level parallelism, so more channels helps to increase the number of concurrently active PEs, which can reduce latency. To achieve the low latency in such a network, the searched accelerators may include a relatively larger array of PEs to accelerate the speed. Finally, the selected weight stationary (WS) dataflow is generally known to be good for achieving the low latency.

The energy-oriented network (FIG. 11) may include a relatively larger kernel size (7×7 MBConv) along with a smaller channel width. Although the PE usage rate decreases and the latency increases as the kernel size increases, the large number of unused PEs may not significantly contribute to high energy. That is, the dynamic energy consumption may mainly depend on the number of MAC operations and data accesses. On the other hand, the smaller the channel widths, the lower the number of accesses for input/output activation, so the energy consumption may be lowered. Comparing a layer with the same MAC operation of a small kernel/wide width and a layer with a large kernel/narrow width, the former may have better latency due to high PE utilization, and the latter may have better energy consumption due to low data access. The accelerator for the energy-oriented cost function has often been searched as having the RS dataflow that are known to exhibit good energy efficiency. The PE array may be small to reduce the energy consumption. Since there is only one output channel in depth-wise convolution, PEY can be particularly small, and reducing the PEY for low energy may be more beneficial than reducing PEX. Each PE may have a larger RF compared to the latency-oriented design. This is because the larger the RF, the less access to the global buffer (GB) and the less the energy consumption.

Comparison of DANCE with Existing Co-Exploration Algorithms

Table 3 below may correspond to the result of comparing the DANCE with other accelerator/network co-exploration algorithms (i.e., Alg. [10] to [14] and [17]).

TABLE 3

| | | | | | | | Net-HW |
|---|---|---|---|---|---|---|---|
| Alg. | Backbone | Dataset | Acc.(%) | GPU-hours | Candidates | Method | Relation |
| [11] | Custom | DAC-SDC | 68.6 | N/A | 68 | CD* | ✓ |
| [12] | Custom | CIFAR-10 | 89.7 | N/A | N/A | RL | ✓ |
| [13] | ResNet-9 | CIFAR-10 | 93.2 | 3.5 h | ~160 | RL | ✓ |
| [14] | NASBench | CIFAR-100 | 74.2 | 2300 h | 2300 | RL | ✓ |
| [10] | ProxylessNAS | CIFAR-10 | 85.2 | 103.9 h | 308 | RL | ✓ |
| [17]^{†} | ProxylessNas | CIFAR-10 | 94.4 | 3 h | 1 | gradient | X |
| DANCE | ProxylessNAS | CIFAR-10 | 95.0 | 3 h | 1 | gradient | ✓ |

^{†}Reproduced and modified for the same setting
*CD = Coordinate Descent

Since all environments are different (e.g., ASIC vs FPGA, different technology nodes, different NAS backbones, etc.), it is not possible to directly compare the measured values. Also, even the accuracy may not be directly compared because it relies on the underlying NAS algorithm. However, if the difference is large, it can imply the searching capability of the method, so accuracy and search cost can be summarized for rough comparison.

Most co-exploration algorithms may utilize reinforcement learning and may have a problem of having to train many candidates in the exploration process. As a result, many of them may only output suboptimal network architectures with poor accuracy.

The search time may also represent an advantage of the DANCE, and may be much faster compared to RL-based tasks. For the algorithm [13], the difference is small, but this is because the backbone architecture is based on a manually fine-tuned architecture with a small model size. The ‘candidates’ column may correspond to an attempt to fairly compare search costs in consideration of this case. That is, it may correspond to the number of candidates that each algorithm needs to train during the search. The RL-based co-exploration algorithms may need hundreds to thousands of candidates for training, but the DANCE may only use one candidate. Algorithm [17] is differentiable and may provide similar accuracy and search cost when reprocessed with the same NAS backbone. However, since the algorithm [17] may not reflect the network-hardware relationship, the co-exploration solution may provide much lower quality than the DANCE.

The DANCE, the co-exploration method according to the present disclosure, may correspond to a new differentiable method to jointly explore hardware accelerators and network architectures targeting both high accuracy and low cost metrics. The co-exploration method according to the present disclosure may model neural network-based hardware evaluators to obtain efficient hardware designs without compromising accuracy with very low search costs. The co-exploration method according to the present disclosure may reduce costs for the co-exploration problem in many future fields, such as video or natural language processing.

Although exemplary embodiments of the present invention have been disclosed hereinabove, it may be understood by those skilled in the art that the present invention may be variously modified and altered without departing from the scope and spirit of the present invention described in the following claims.

What is claimed is:

1. An artificial neural network and computational accelerator structure co-exploration apparatus, comprising:
a neural architecture search (NAS) module configured to determine neural network architecture; and
a differentiable accelerator and network co-exploration (DANCE) evaluation module configured to determine accelerator architecture according to the determined neural network architecture and predict hardware metrics for the determined accelerator architecture.

2. The apparatus of claim 1, wherein the NAS module simultaneously evaluates a plurality of candidate neural network architectures to select the neural network architecture and calculate a cross-entropy loss (LossCE).

3. The apparatus of claim 1, wherein the DANCE evaluation module is constructed through pre-training, and includes: a hardware generation network configured to be built through pre-training, explore optimal hardware according to the determined neural network architecture as the accelerator architecture, and determine at least one of a processing element (PE) array configuration (PEx and PEy), a register file (RF) configuration, and a dataflow (DF) configuration; and
a cost estimation network configured to predict the hardware metrics based on configurations of the accelerator architecture.

4. The apparatus of claim 3, wherein the hardware generation network generates random networks within a network architecture space and determines one of the random networks as the optimal hardware.

5. The apparatus of claim 4, wherein the hardware generation network explores the random networks by being configured as multi-layer perceptrons using a rectified linear unit (ReLU) as an activation function.

6. The apparatus of claim 5, wherein the hardware generation network makes an output value approach an input value of the cost estimation network in a manner of feature forwarding the output value to the input value by connecting the last of the multi-layer perceptrons with Gumbel-Softmax.

7. The apparatus of claim 3, wherein the cost estimation network is configured as a multi-layer regression that uses a rectified linear unit (ReLU) as an activation function and applies batch normalization to each layer.

8. The apparatus of claim 7, wherein the cost estimation network predicts the hardware metrics by determining latency, area, and energy consumption through the multi-layer regression.

9. The apparatus of claim 8, wherein the cost estimation network predicts the hardware metrics by calculating a linear combination or a product of the latency, the area, and the energy consumption

10. An artificial neural network and computational accelerator structure co-exploration method, comprising:
performing a NAS module that determines neural network architecture; and
performing a DANCE evaluation module that determines accelerator architecture according to the determined neural network architecture and predicts hardware metrics for the determined accelerator architecture.

11. The method of claim 10, wherein the performing of the DANCE evaluation module constructed through pre-training includes:
performing a hardware generation network that explores optimal hardware according to the determined neural network architecture as the accelerator architecture, and determines at least one of a processing element (PE) array configuration (PEx and PEy), a register file (RF) configuration, and a dataflow (DF) configuration; and
performing a cost estimation network that predicts the hardware metrics based on configurations of the accelerator architecture.

12. The method of claim 11, wherein the performing of the hardware generation network includes generating random networks within a network architecture space and determining one of the random networks as the optimal hardware.

13. The method of claim 12, wherein the performing of the hardware generation network includes exploring the random networks by being configured as multi-layer perceptrons using a rectified linear unit (ReLU) as an activation function.

14. The method of claim 11, wherein the performing of the cost estimation network includes configuring the cost estimation network as a multi-layer regression that uses a rectified linear unit (ReLU) as an activation function and applies batch normalization to each layer.
